(19) United States
(12) Patent Application Publication
(10) Pub. No.: US 2005/0166566 A1
(43) Pub. Date: Aug. 4, 2005

(54) High capacity sickle section

(75) Inventor: David S. Majkrzak, West Fargo, ND (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: TerraMarc Industries, Inc., West Fargo, ND (US)

(21) Appl. No.: 10/772,122

(22) Filed: Feb. 4, 2004

(51) Int. Cl. A01D 34/00

(52) U.S. Cl. 56/246

(57) ABSTRACT

A sickle knife section is adapted to be used with existing sickle guards in connection with a harvester, mower or the like. The knife sections have concave cutting edges on opposite sides of a central plane that are circular, and the cutting edges are along a line that moves away from a central plane of the knife section from a leading end of the knife section to position where the concave cutting edges intersect side edges of the knife section.

### BACKGROUND OF THE INVENTION

The present invention relates to a sickle section used on cutter bars for harvesters, which has concave side edges formed in a general continuous laterally expanding curve from the lead or tip end to the base end of the cutting edges. This configuration is to cut many small stalks and to get as many stalks as possible on each stroke.

In the prior art, sickle sections have been advanced that have curved edges, such as that shown in U.S. Design Pat. No. D912,164. However, the capacity of these sections is compromised by having edges that, while curved, do not continuously expand laterally outward from the tip or lead end to the base.

Another type of harvester cutter sickle section is shown in U.S. Design Pat. No. D354,786 with a compound curvature, rather than a continuous single curved edge.

Similar structures are shown in U.S. Pat. No. 3,538,693 where a lawn mower cutter bar is provided.

### SUMMARY OF THE INVENTION

The present invention relates to a sickle section for a cutter bar, such as on a harvester or a mower, which is made to provide for very high capacity cutting. The sickle section has opposite side edges that form cutting edges. The cutting edges are curved and concave. The edges are configured so they expand laterally from the leading end of the sickle section, that is, from the leading end facing in the direction of movement. The leading end is the first portion to engage crop material.

As the combine or harvester moves, the leading edge is the most narrow portion of the sickle section, and the edges curve outwardly in opposite directions continuously to the lateral side edges of the sickle section adjacent the base or mounting portion of the sickle section. The effective edges are also smoothly curved and are not deeply scalloped or undulating. However, the edge of the section can be serrated, with the points of serration lying along a smooth curve.

This configuration forms edge recesses that will engage the standing crop material to be cut, and will not tend to push the crop material out of the way. Rather, the sickle section provides a smooth cut as the sickle section passes through a mating guard that is utilized.

### BRIEF DESCRIPTION OF THE DRAWINGS

FIG. 1 is a top plan view of a portion of a cutter bar for a harvester, having a sickle utilizing sickle sections made according to the present invention used with sickle guards shown in U.S. Pat. No. 4,651,511;

FIG. 2 is a sectional view taken as on line 2-2 in FIG. 1;

FIG. 3 is a bottom plan view of a portion of a cutter bar showing the sickle guards used;

FIG. 4 is a top plan view of a single sickle section made according to the present invention; and

FIG. 5 is a perspective view of a single sickle section made according to the present invention.

### DETAILED DESCRIPTION OF THE PREFERRED EMBODIMENTS

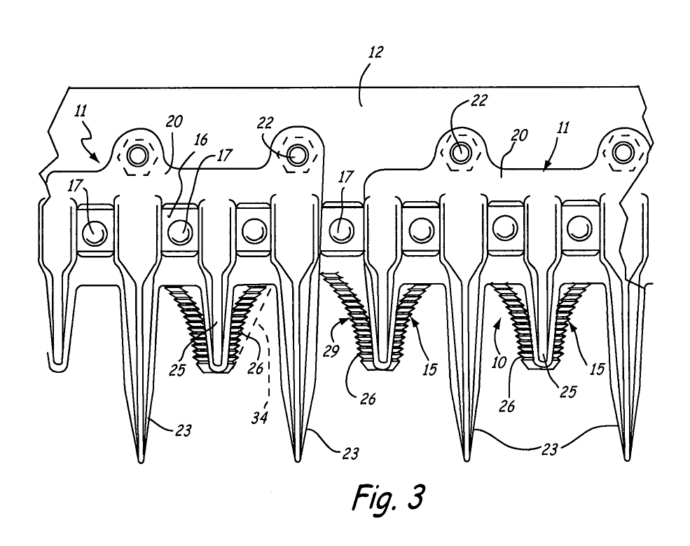

A fragmentary portion of a cutter or sickle bar 10 used with a harvester that is of substantially conventional design, supports a number of guard sections 11 that are secured to the guard support bar 12. The bar 12 is of a selected length to provide the necessary length for the harvester header. The guards, as shown, can be of any desired design, and as shown, these guards have base supports 20 that support guard fingers 23 extending outwardly from the base supports. The base supports are bolted to the guard support bar 12 with suitable fasteners 22. This type of guard also has a short finger 25 underlying the sickle knife sections, as shown in FIG. 3.

The sickle knife sections indicated generally at 15 and which are made according to the present invention are supported on a bar 16, which can be seen in FIG. 2, utilizing suitable fasteners 17, such as bolts and nuts or rivets as shown as is well known.

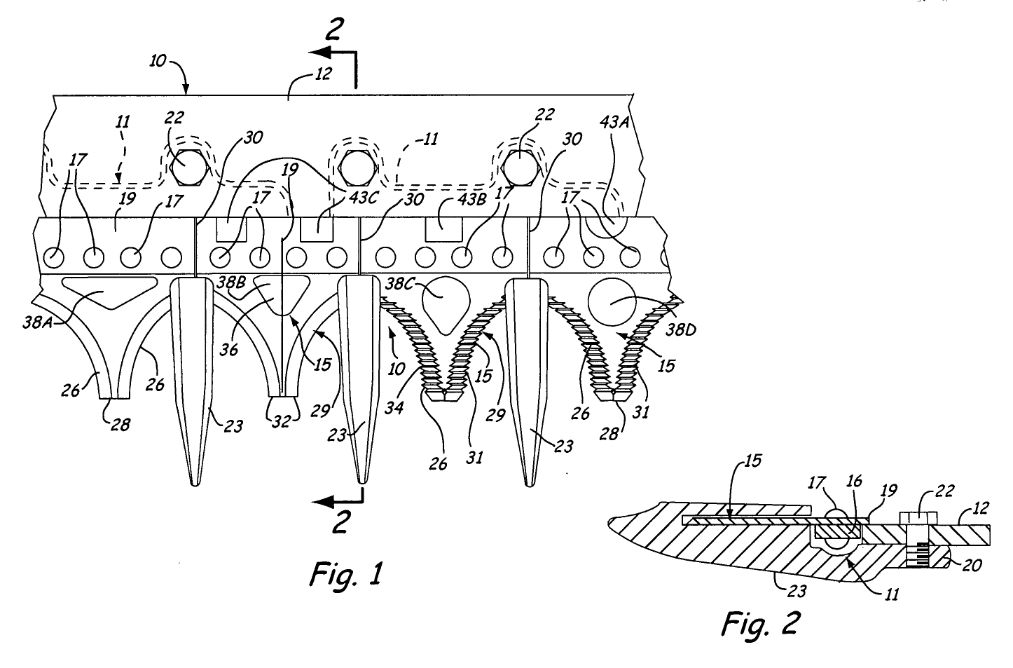

The sickle knife sections 15 of the present inventions are reciprocated along the longitudinal axis of the sickle bar, using a normal reciprocating drive. The sickle knife sections 15 are illustrated in FIG. 1 in connection with guards shown in U.S. Pat. No. 4,651,511. Conventional guards can also be used. The conventional guards would be like the FIG. 1 showing, but without the shorter underlying fingers 25.

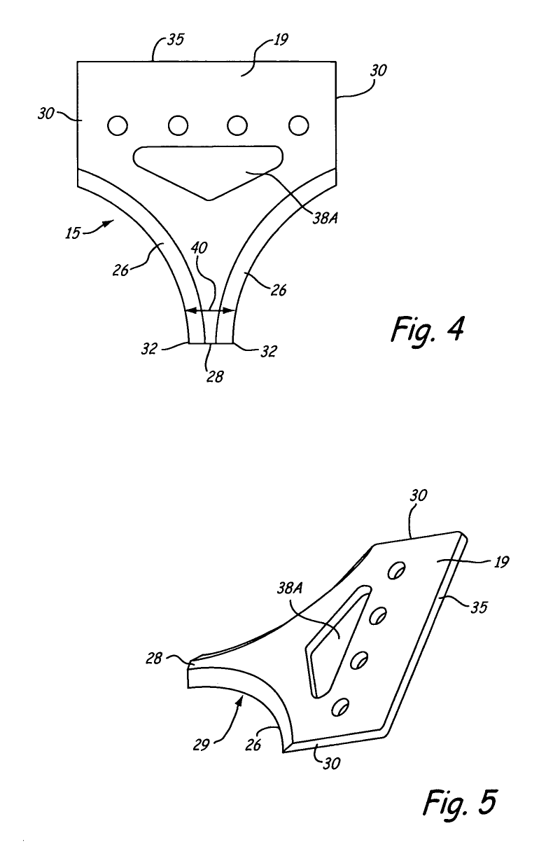

The sickle knife sections 15 have a base 19 with concave, curved cutting edges or curved cutting lines 26 on opposite sides thereof that are made so that the edges 26 or a line joining the points of serration form a continuous, circular laterally extending curve from a leading end 28 to the lateral side edges 30 of the base of the individual sickle knife sections. The lateral side edges 30 are part of the base 19 and are positioned along the sides of base 19. The curved edge 26 is beveled to form a cutting edge or can be serrated, as is well known and shown at 31 on two of the sections in FIG. 1. The curved edges or cutting edge lines 26 continuously expand laterally from adjacent points 32 at the opposite sides of the leading end 28 out to where the edges or cutting edge lines 26 intersect the side edges 30. The cutting edges adjacent points 32 can be nearly linear and parallel for a short distance as being tangent to the circular form of the cutting edges, but the opposite edges do not move toward the fore and aft center line 36 of the sickle knife section. In other words, the space between the edges or cutting edge lines 26 shown by double arrow 40 in FIG. 4 does not reduce at any location.

It can be seen that the recess 29 formed by the concave edges or cutting edge lines 26 will receive crop material between the respective edge and the adjacent guard point or finger 23 on 25, and will greatly increase the capacity of the sickle knife section relative to the normal tapered section where a straight line tapered edge is used. A straight line tapered edge is indicated in dotted lines at 34 in FIGS. 1 and 2 at one of the sickle sections. The straight lateral side edges 30 of the base 19 extend from a base line 35 of the base 19 about one-half of the distance from base line 35 to the leading end 28.

The curved shape of each edge 26 is designed to increase the capacity of the sickle for cutting crop materials when used with sickle guards. Crop materials are small diameter stalks and large bunches are gathered and severed with each stroke of the sickle.

Again, the leading end 28 of each knife section has a width, but the sharpened edges 26, from the points 32 out to the side edges 30 are continuously curved so that they are outwardly expanding, concave edges.

Preferably, the edges 26 are a portion of a circle, although other shapes that would not provide edges that taper toward each other or move inwardly toward the center line plane shown at 36 can be used.

In other words, there are no pockets or recesses in the edges 26 from the place where the material enters the space between adjacent sickle knife sections to the point where the cutting edges terminates along sides of the sickle knife section base. There are cutters for brush, branches and the like where a single stalk is to be severed and “pockets” along the edges help to trap a branch.

If desired, a weight reduction openings 38A, 38B, 38C and 38D of different configurations also can be provided in the body of the sickle sections of the present invention, as is conventionally done at the present time. Also, weight reduction openings of various designs as shown at 43A, 43B or 43C can be provided in the base 19 of the sickle sections.

Although the present invention has been described with reference to preferred embodiments, workers skilled in the art will recognize that changes may be made in form and detail without departing from the spirit and scope of the invention.

The sickle sections of the present invention are for cutting smaller dramatic stalks of cup materials, such as hay or small ______, and the goal is to get as many as possible cut with each stroke.

1. A knife section for a reciprocating sickle bar for a harvester, said knife section being flat and having a top surface plane and comprising a base, the knife section having a leading end spaced from the base, mounting holes in the base for securing the knife section to a support bar, the knife section having a central dividing plane perpendicular to the top surface plane of the knife section and the base having side edges parallel to the central dividing plane, the leading end being of substantially less lateral width perpendicularly to the center dividing plane than a width between the side edges of the base, a pair of cutting edges, one on each side of the knife section and each cutting edge defining a cutting line that continually moves away from the center plane of the knife section from a first end of such cutting line adjacent the leading end to a second end of the cutting line at a junction of the cutting line with a respective side edge on the respective side of the base of the knife section, and each cutting line being concave with respect to a straight line between the first and second ends of the respective cutting line.

2. The knife section of claim 1, wherein said leading end has a surface transverse to the central plane of the knife section.

3. The knife section of claim 1, wherein each side edge is substantially between 40% and 50% of the distance from a base end of the knife section to the leading end thereof.

4. The knife section of claim 1, wherein said cutting line is part of a circle.

5. The knife section of claim 1, wherein each cutting edge is serrated, with outer serration points lying along the respective cutting line.

6. A knife section for a reciprocating sickle, the knife section having a leading end and a base end with side edges, a pair of smoothly curved concave cutting edge lines extending from the leading end to a respective side edge without reducing the distance from the cutting edge line to a central plane perpendicular to the knife section.

7. The knife section of claim 6, wherein each cutting line lies along a smoothly sharpened edge of the knife section.

8. The knife section of claim 6, wherein each cutting edge line lies along points of cutting edge serrations on the knife section.

9. A double edge knife section for a reciprocating sickle, the knife section having a leading end and a base end with opposite side edges, a knife section plane extending between the side edges, a pair of smoothly curved concave cutting edge lines extending from the leading end to a respective side edge of the base, the distance from each cutting edge line to a bisecting central plane perpendicular to the knife section plane expanding in a concave curve continually from adjacent the leading end to the respective base side edge.

10. The double edge knife section of claim 9, wherein each cutting edge line lies along a smoothly sharpened edge of the double edge knife section.

11. The double edge knife section of claim 9, wherein each cutting edge line lies along points of cutting edge serrations on the double edge knife section.

12. The double edge knife section of claim 9, wherein the double edge knife section is symmetrical with respect to the bisecting central plane.

13. The double edge knife section of claim 9, wherein side edges of the knife section taper from the cutting edge line upwardly toward the central plane.
